(19) United States
(12) Patent Application Publication
(10) Pub. No.: US 2007/0083549 A1
(43) Pub. Date: Apr. 12, 2007

(54) Method and mechanism for providing a caching mechanism for contexts

(75) Inventors: David Kogan, San Mateo, CA (US); Ravikanth Kasamsetty, Union City, CA (US)

Correspondence Address: ORACLE INTERNATIONAL CORPORATION;c/o BINGHAM MCCUTCHEN LLP, THREE EMBARCADERO CENTER, SAN FRANCISCO, CA, 94111-4067, US

(73) Assignee: ORACLE INTERNATIONAL CORPORATION, REDWOOD SHORES, CA (US)

(21) Appl. No.: 11/247,972

(22) Filed: Oct. 10, 2005

(51) Int. Cl. G06F 17/00

(52) U.S. Cl. 707/103 R

(57) ABSTRACT

Disclosed is a system and method for improving the performance of marshalling and un-marshalling operations. In one approach, the system and method can be used to improve the performance of marshalling and un-marshalling operations in databases that support opaque types. The system and method is configured to allow aggregated objects to share data within the contexts. The described approach can also be used for other types of processing of a hierarchy of objects not involving marshalling and un-marshalling.

### BACKGROUND

In object-oriented as well as object relational systems, marshalling and un-marshalling are very common operations. Marshalling is also commonly termed “serializing”, “linearizing”, or “pickling”. Similarly, un-marshalling is also commonly termed “deserializing”, “delinearizing”, or “unpickling”. Each of these terms may be used interchangeably in this document.

These operations are often used, for example, to package hierarchies of information for transmission from one location to another. Because these operations are so frequently used, their performance is extremely critical to any computing system, such as a database system.

In the process of pickling (linearizing) an object into an image (stored on disk or transmitted) or unpickling (delinearizing) an image into an object in memory, a set of information relating to the pickling operation needs to be tracked. This information includes, for example, metadata about the object and image, locators for the current position in both, data about the process and database, and a variety of temporary data used in the creation of the object. This data is gathered into data structures referred to as “contexts.”

The allocation and initialization of a context for any kind of object processing takes significant time, since these contexts tend to be large and considerable computation goes into some fields.

Objects can often be organized in two ways: by aggregation and association. Aggregated objects comprise one data structure, while associated objects are data structures related to each other indirectly. These are very commonly used terms in object-oriented modeling to describe relationships between the objects. For example, when a customer places an order, the order is one aggregate data structure. A top-level order object could include a price summary object, a shipping slip object, and a billing information object. Associated with this data structure could be other information—for example, each item in the price summary object could have an object describing the item purchased. Associated objects are commonly retrieved along with each other, but need to be processed separately, because they behave differently: an order object is related to a given customer, whereas an item object is generic for the store.

When processing objects like this, there is usually a significant amount of metadata involved. In part, this is because conventionally, each object (e.g., order, summary, billing, shipping, and item) uses its own context, each requiring initialization (and possibly allocation) for every call. This is due, for example, to the use of “opaque objects.” in many database systems.

Many advanced databases support opaque types, which are user-defined types that are not known or native to the database system. Instead, these user-defined types are typically custom-created by the user. The reason for these custom datatypes is that many database users/clients want to be able to define their own structures that use system objects, but are processed by the clients. For example, an online merchant might want to implement its own Description object that includes complex information of the relationships between different products in its database. At the same time, they could use standard system types, such as a Text object as part of the Description object. Opaque types are described, for example, in U.S. Pat. No. 6,470,348, which is hereby incorporated by reference in its entirety.

Opaque datatypes are often implemented by requiring the user to provide specialized functions that the database system will use to access and manage these opaque types. In such environments, functions such as marshalling or un-marshalling for the opaque datatypes may be handled by specialized functions provided by the users. Because of this, the processing of different objects during serializing and unserializing operations can enter and re-enter the system functions at many levels.

Consider, for example, the following un-marshalling function:

```
sys_unmarshall(O, {optional argument Association})
  for each attribute A of O {
    if A is scalar, process
    else if A is aggregate system object
      call sys_unmarshall(A)
    else if A is associate system object
      call sys_unmarshall(A,Association)
    else if A is user defined object
      call user_unmarshall(A)
  }
```

In one approach, each call to sys_unmarshall (and a similar call to a marshall function) requires a separate context allocation and initialization.

To illustrate, consider the example scenario shown in FIG. 1A. This figure shows a first hierarchy of aggregated objects A, A1, and A2. The figure also shows a second hierarchy of aggregated objects B, B1, and B2. An association exists between object A and object B.

In this example, the pickling process caused a separate allocation and initialization of context metadata for each object. For example, processing of object A will result in the allocation of a context C_{A}. Similarly, processing of objects A1, A2, B, B1, and B2 will result in the allocation of a contexts C_{A1}, C_{A2}, C_{B}, C_{B1}, and C_{B2}.

One reason for this type of result is that the hierarchy of objects may include the presence of opaque datatypes. This is illustrated in FIG. 1B in which the hierarchy of native B, B1, and B2 database objects now includes an opaque object O. In a circumstance such as this, the process of linearizing the hierarchy of B objects would involve a native system call to process native object B, with a call to a user-provided pickling function to process object O, as well as calls to native pickling functions to process native objects B1 and B2. Since the entry point to process a native object may occur from a previous processing of an opaque object, the system may not know that any given object is able to share the metadata for any other object. In this example, the system may not even know about the presence of the B1 and B2 object until the opaque object O has been processed, since it is beneath O in the hierarchy. As a result, each object will be assigned and allocated to its own context/metadata. Because of this result, many more contexts are cached than is necessary given the nature of objects being processed, and therefore the initialization at the many entry points for a complex object can cause significant performance issues.

To address these and other problems, described is a method and system that significantly improves the performance of marshalling and un-marshalling operations. In one embodiment, the described approach can be used to improve the performance of marshalling and un-marshalling operations in databases that support opaque types.

### BRIEF DESCRIPTION OF DRAWINGS

FIGS. 1A and 1B illustrate example scenarios in which hierarchies of objects are processed for marshalling and un-marshalling.

FIG. 2 shows a flowchart of a process for sharing contexts.

FIG. 3 illustrates sharing of contexts.

FIGS. 4 and 5 show flowcharts of processes to implement an embodiment of the invention.

FIGS. 6A-I illustrate an application of the processes of FIGS. 4 and 5.

FIG. 7 illustrates an example computing architecture with which embodiments of the invention may be practiced.

### DETAILED DESCRIPTION

Embodiments of the present invention provide a method and system that significantly improves the performance of marshalling and un-marshalling operations. In one embodiment, the described approach can be used to improve the performance of marshalling and un-marshalling operations in databases that support opaque types.

In one embodiment of the invention, the system and method is configured to allow aggregated objects to share data within the contexts. For example, consider the aggregation scenario in which a customer places an order and the order is one aggregate data structure. A top-level order object could include a price summary object, a shipping slip object, and a billing information object. Associated with this data structure could be other information—for example, each item in the price summary object could have an object describing the item purchased. In this example, the aggregated objects can share much of the data within these contexts, since order object, price summary object, shipping slip object, and billing information object all likely have the same level of persistence, the same language information, the same ownership, etcetera. It is therefore desired, in order to optimize the process, to use one context within one aggregate set.

In contrast, associated objects, generally have differing metadata. Using the example above, the associated item object may have a much longer persistence, may store multiple languages, and has different ownership from the order objects. It is desired to use a different context when processing it. Therefore, according to one embodiment, context metadata is shared by objects within an aggregation relationship, but are not shared across an association relationship. However, to optimize performance, it is desired to process associated objects at the same time as aggregate objects, since they are often retrieved, viewed and stored at the same time.

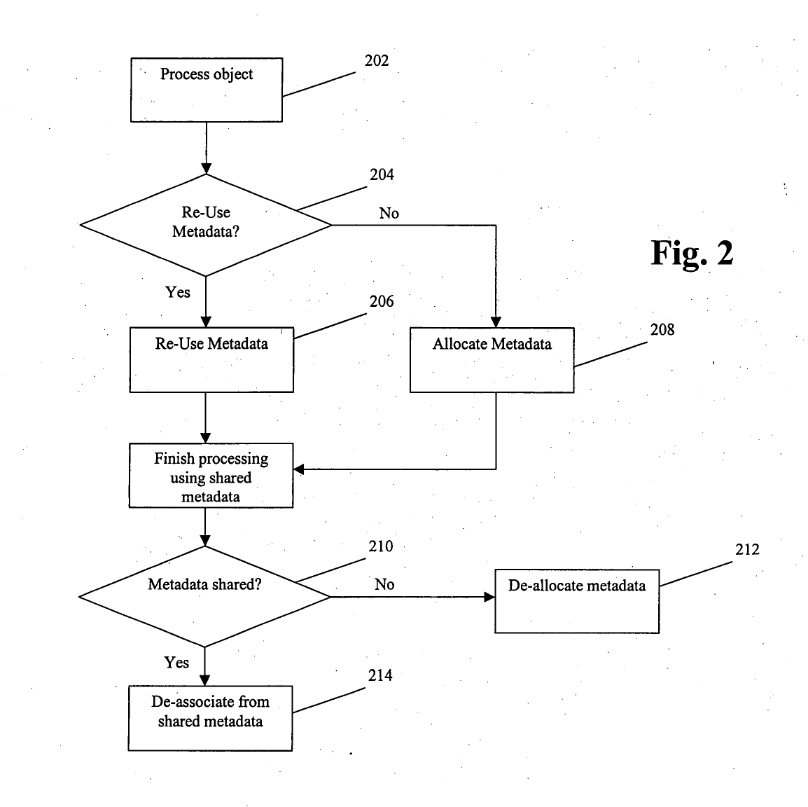

FIG. 2 shows a high-level flowchart of a method for processing objects during (de)linearization according to one embodiment of the invention. At 202, an object is processed for either linearization or de-linearization. A determination is made at 204 whether there is existing metadata that can be re-used and shared with the object under scrutiny. One approach for accomplishing this action is to determine whether the object is within an aggregation relationship with another object for which a context object has already been allocated and initialized. If so, then that previously allocated metadata is re-used for the present object (206). Otherwise, a new metadata object is allocated and initialized for the object (208).

Once the linearization (or de-linearization) process is completed for the object, a determination is made whether that metadata that has been employed is a shared object (310). If it is not a shared object, then that meta-data is de-allocated and released to be newly allocated and used by other objects (212). If it is a shared object, then the object is merely disassociated from the metadata without causing it to be de-allocated (214).

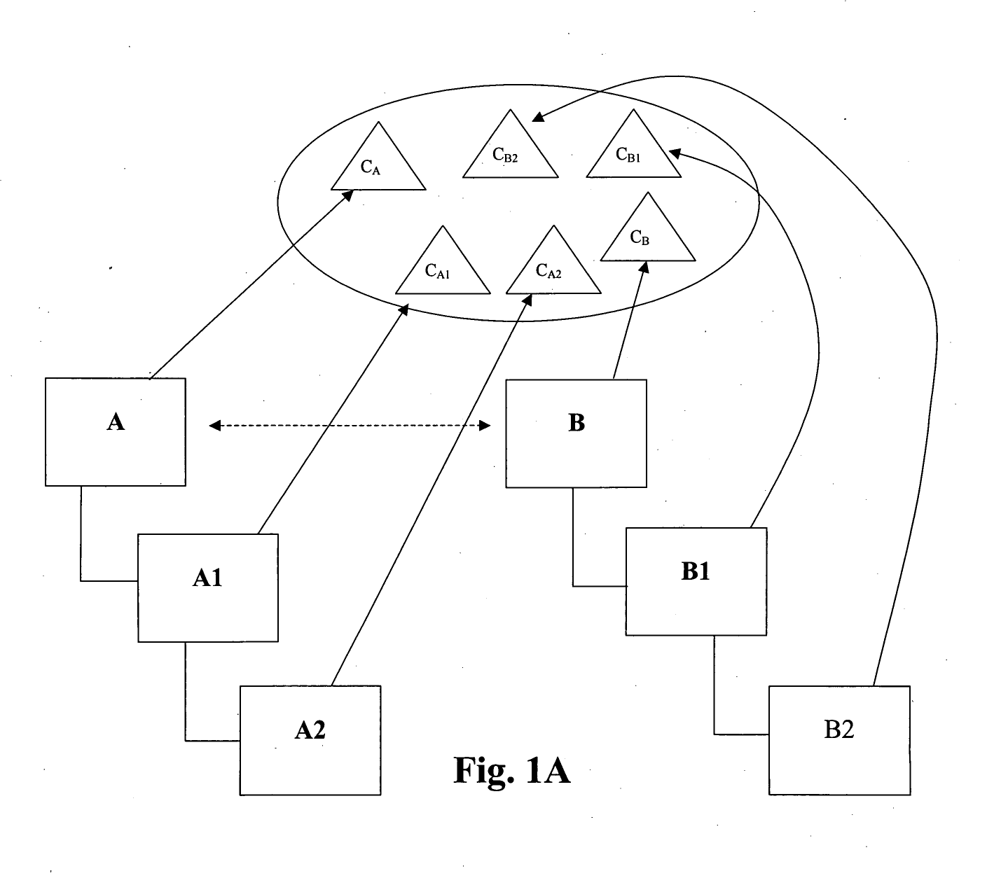

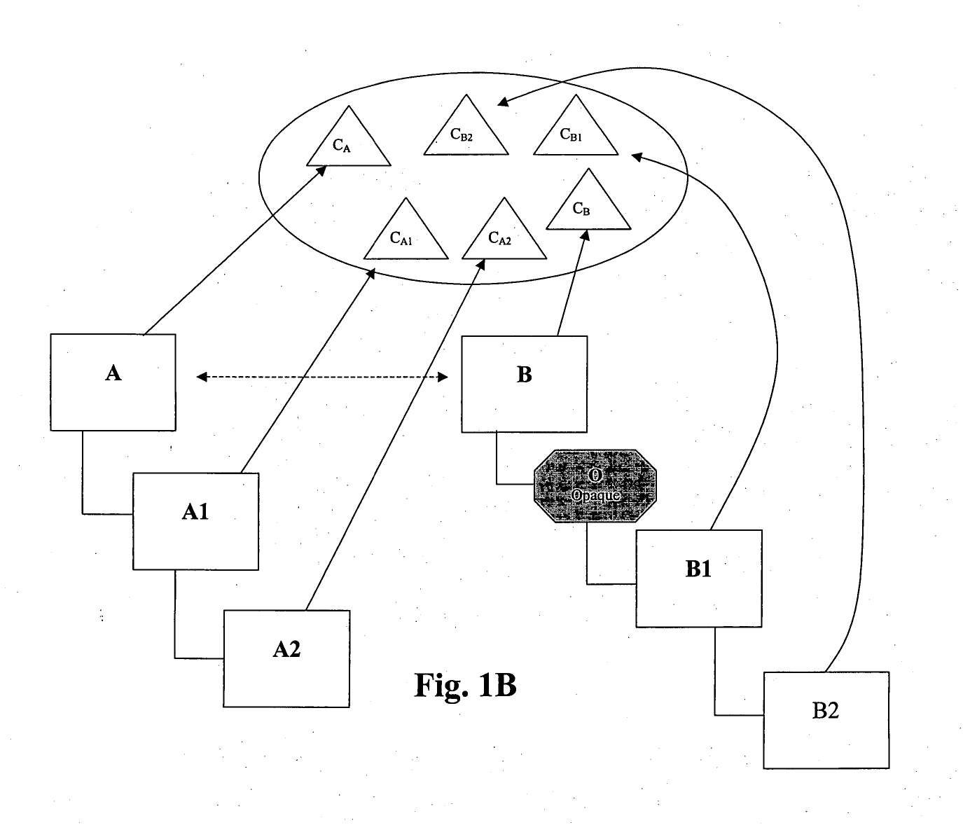

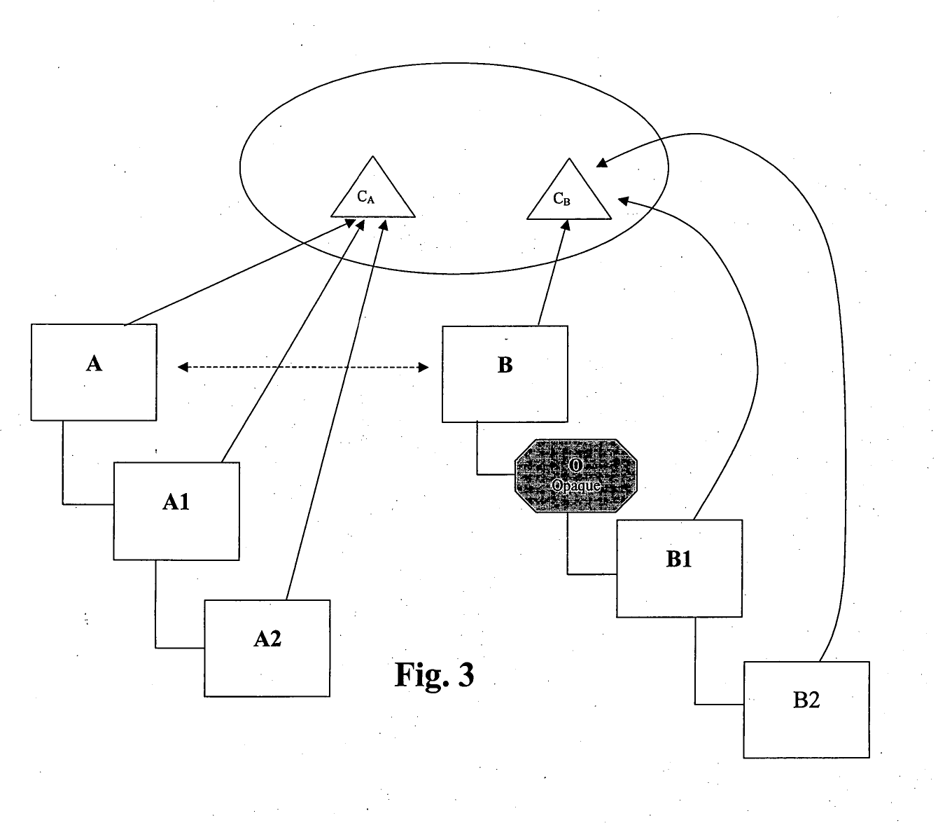

FIG. 3 illustrated the application of this process to the objects illustrated in FIG. 1B. In particular, the linearization process now causes the same metadata object C_{A} to be shared by all of the objects within the hierarchy of aggregated objects A, A1, and A2. Similarly, the same metadata object C_{B} is shared by all of the objects within the hierarchy of aggregated objects B, B1, and B2.

In order to be able to use one context for any given aggregated set of objects, and not re-use contexts between different associated sets of aggregated objects, one embodiment of the invention makes use of the following:
1) Perform the processing (pickling/unpickling in our case) in a depth first manner. When a new context is set up, the method will not return to any context used earlier until this context is finished.
2) Control the association interaction. The user can begin the processing of a new object, can be called to process user-defined data and then continue the processing of our data, but it is up to the system to decide which objects are associated.
3) Know when the method is done with a given object (but not necessarily at what level of aggregation/association that object exists).

For this embodiment, the method allocates and caches contexts in a globally accessible list, which can be alternatively viewed as a stack, and as a queue, depending on the state of the system. In addition to being part of the list, each context has a count (“refcount”) of the number of times it is being used. The logic for retrieving a context from the list is as described in the following paragraphs.

If the method is processing an association relation (which can be distinguished because it can be controlled), then the list is treated as a queue, and search for the first context in the list, which has a refcount of 0. This means that this context is not being used, and is available to be initialized. If there are no contexts in the list, or none with a refcount of 0, then the method allocates a new one and appends it to the list. The method takes this context and increment this refcount.

If there is nothing on the list, then it is known that the method is processing a top-level object, and the method will allocate a new context, add it to the list, initialize it, and increment its refcount.

If the first context on the list has a refcount of 0, the method knows that it is processing a top-level object, so the method initializes it and increment its refcount.

If is it known that the method is processing a recursive attribute of some object (though not known the level of association or aggregation involved), then the method treats the list as a stack, and search backwards through it to find the first context with a non-zero refcount. The process knows this is the context which was being used for the current recursive object's aggregate top-level parent, and will re-use it without initializing it (but bumping the refcount).

At the end of any object, the method decrements the refcount.

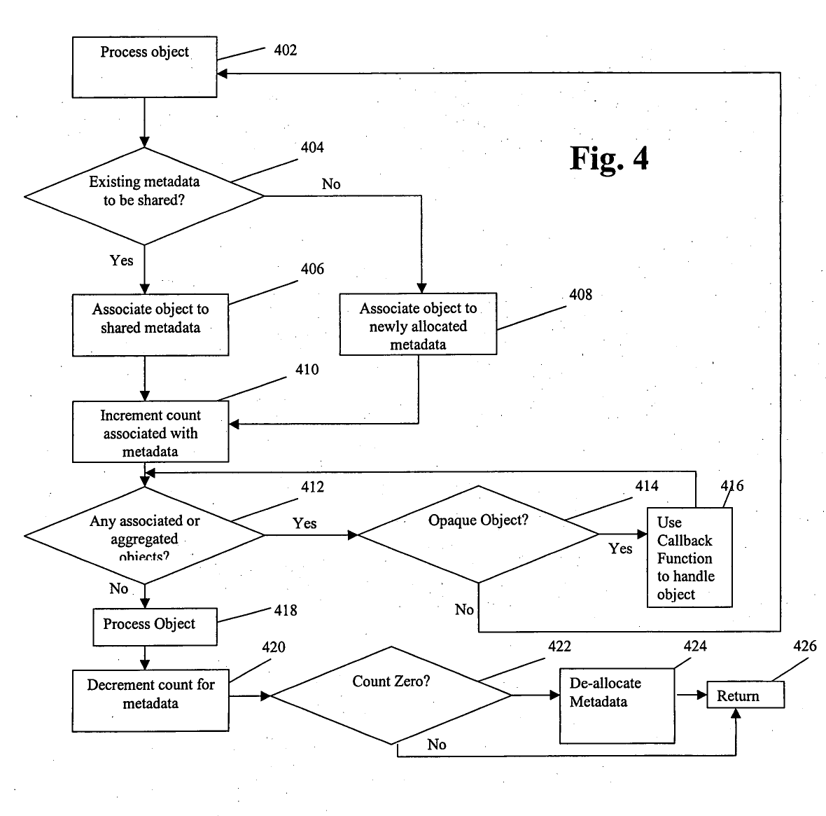

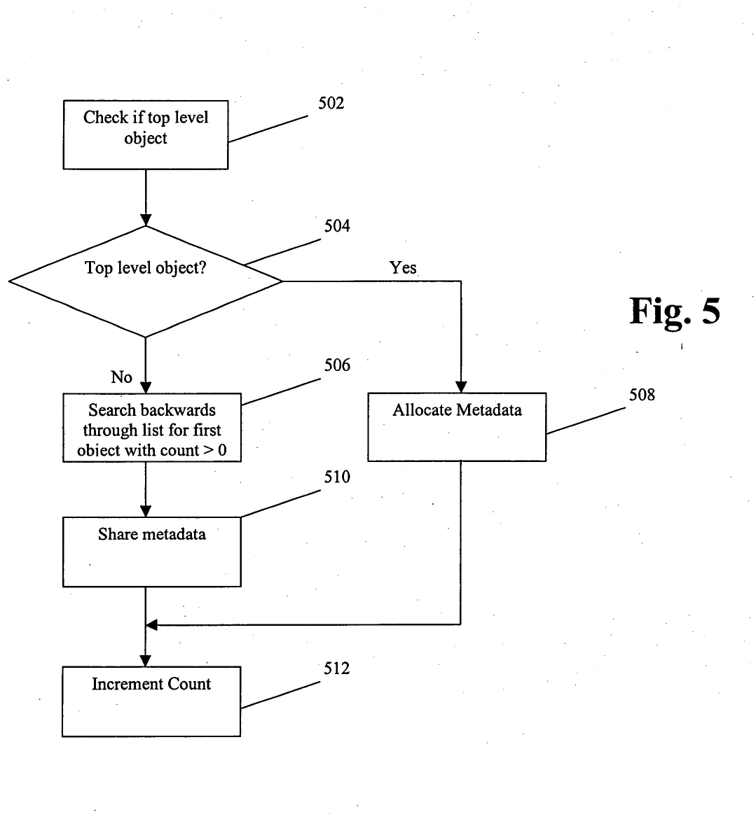

FIGS. 4 and 5 provide flowchart descriptions for this embodiment of the invention. In FIG. 4, the process again begins by processing an object for linearization (402). A determination is made at 404 whether there is existing metadata that can be re-used and shared with the object under scrutiny.

As noted, one approach for accomplishing this action is to determine whether the object is within an aggregation relationship with another object for which a context object has already been allocated and initialized. If so, then that previously allocated metadata is re-used for the present object (406). If, however, the object is part of an association relationship, then the metadata is not shared with a previously allocated metadata. Instead, a new metadata object is allocated and initialized for the object (408).

In either case, the count associated with the metadata is incremented. If the metadata is newly allocated, then the count will increase from 0 to 1. If the metadata was previously allocated and is shared with other objects, then the count will now be greater than one.

A determination is made at 412 whether the object has any associated or aggregated objects. If so, then a further determination is made whether the associated or aggregated object is an opaque object (414). If the object is an opaque object, then it is processed using the user-specified callback function (416) and the process returns back to 412 to identify another associated or aggregated object. If the associated or aggregated object is not an opaque object, then the process returns back to 402 to process that object.

Assuming the method reaches the bottom of the hierarchy at which point there are no further associated or allocated objects beneath the present object in the hierarchy, then the method processes the object under examination for linearization (418). Once this has been completed, the object can be dissociated from the metadata and the count for that metadata object decremented.

If the object just processed was the only object using that metadata, then the count for that metadata has just decremented from 1 to 0. Therefore, if it is determined that the count is zero for the metadata object (422), then that metadata object can now be deallocated (424).

If, however, it is a shared metadata that corresponds to other objects being processed for linearization, then the count for that metadata is greater than zero. Therefore, it cannot yet be deallocated, but must remain available until its other corresponding objects has completed their processing.

The process then returns to a previous object in the depth-first approach of the method (426).

FIG. 5 shows a flowchart of the method for identifying a metadata object to assign to a given object. This method is particularly useful when there exists opaque objects within the aggregation hierarchy of objects, and it is desired to be able to identify existing metadata that can be re-used and shared within that hierarchy.

At 502, a determination is made whether the object is a top-level object within the hierarchy. This type of determination can be made, for example, by checking whether the first allocated metadata has a count that is zero. If so, then the present object is the top-level.

If the object is the top-level object, then the first metadata object on the list is allocated (508) and the count for that metadata is incremented form 0 to 1 (512). If the object is not a top-level object, then the list of metadata is searched in a backwards direction for the first object whose count is greater than zero. The method then causes the object to shared the existing metadata (510), and the count for that metadata is incremented to reflect this newly created correspondence between the object and the metadata (512).

It is noted that information regarding whether a particular set of objects is in an aggregation or association relationship does not necessarily need to be known ahead of time. This is an implementation detail since in some embodiments, this information can be derived, e.g., by examining the objects themselves or environmental information relating to the objects.

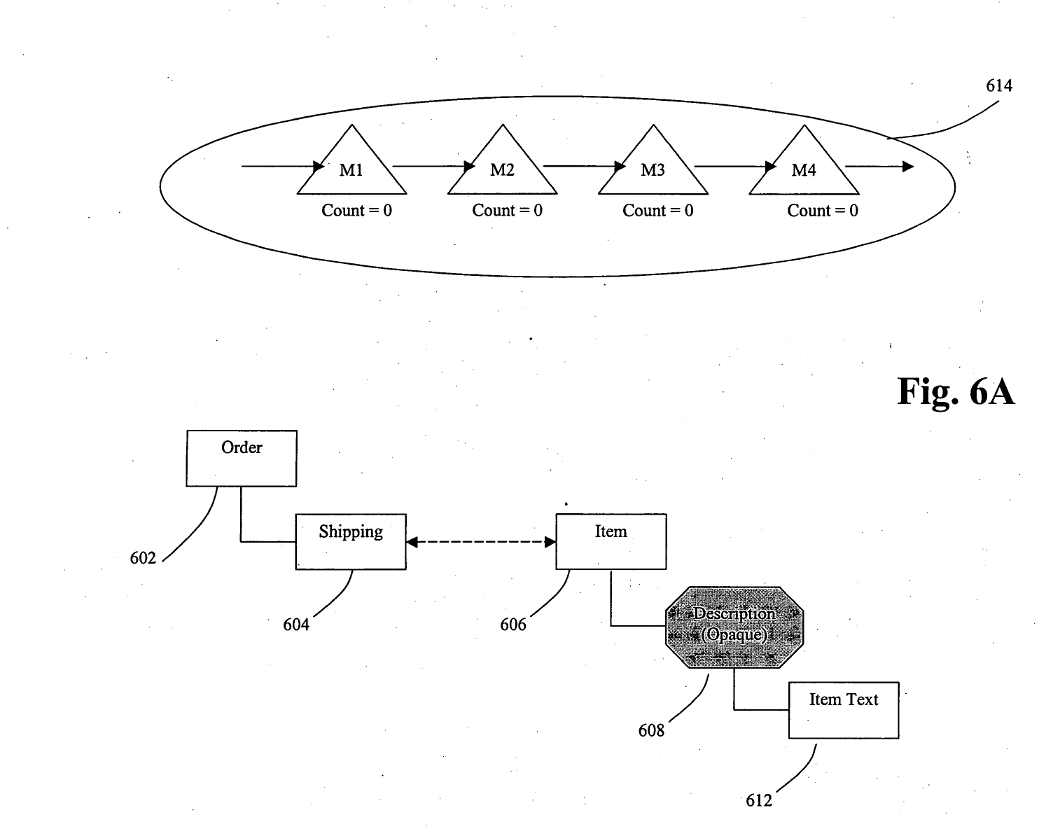

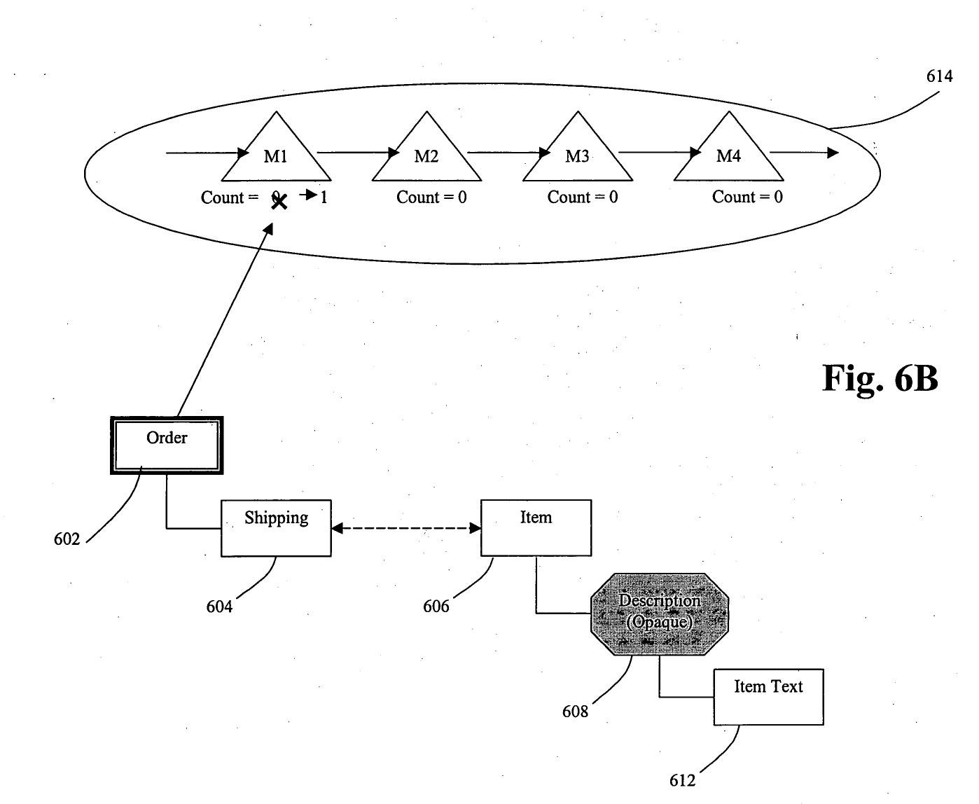

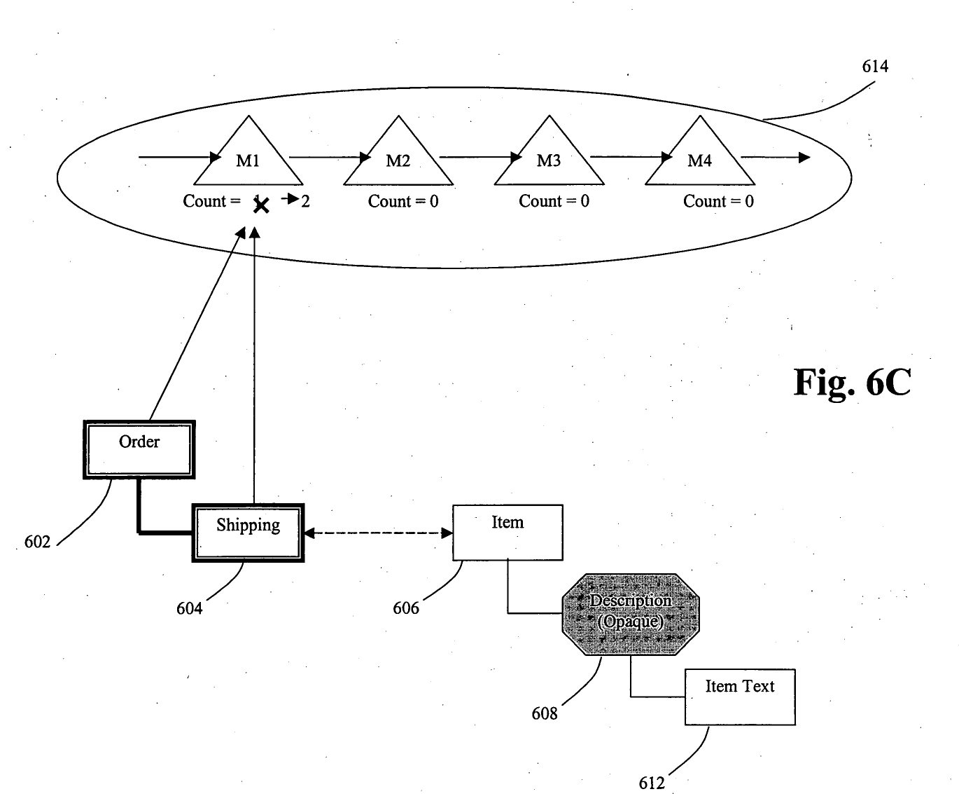

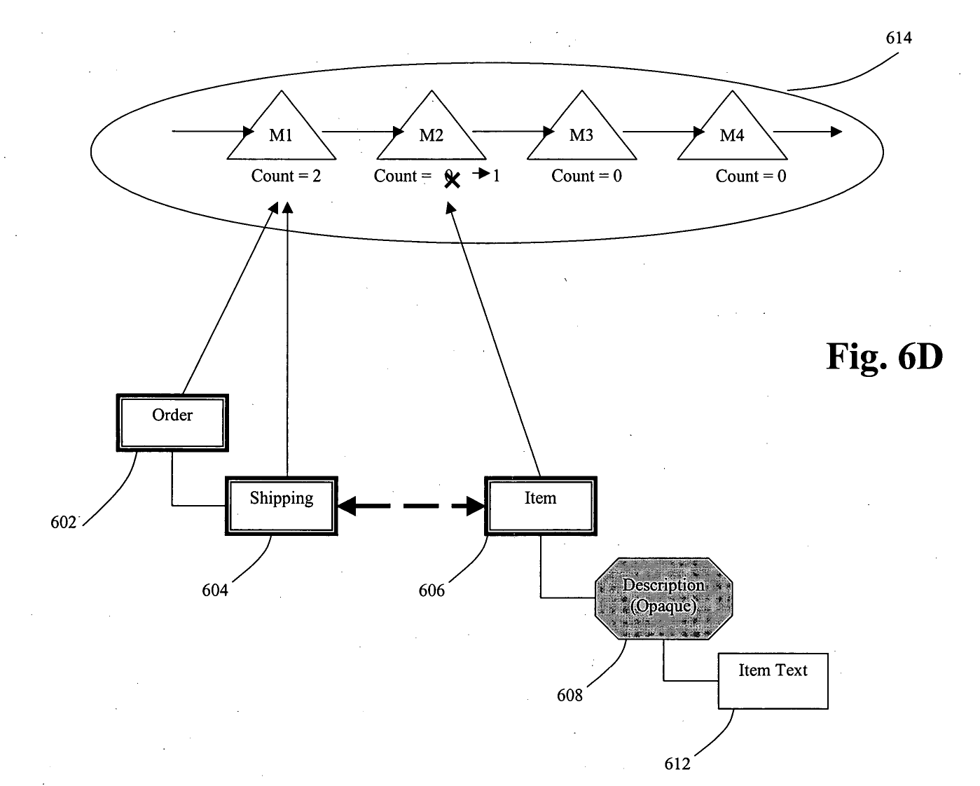

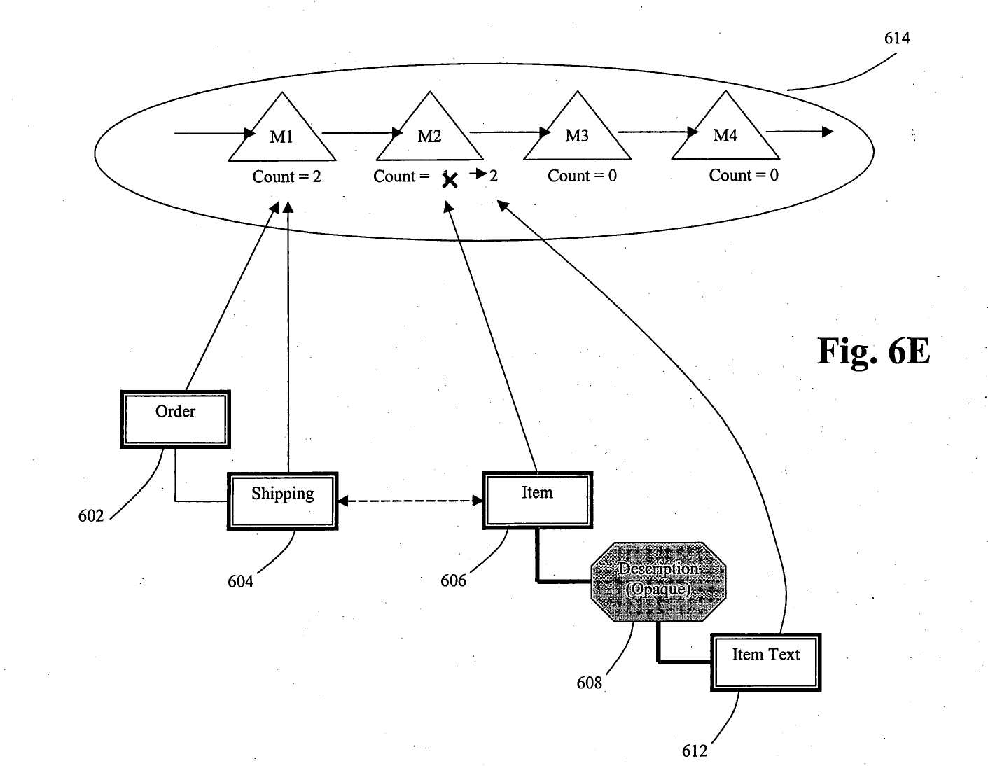

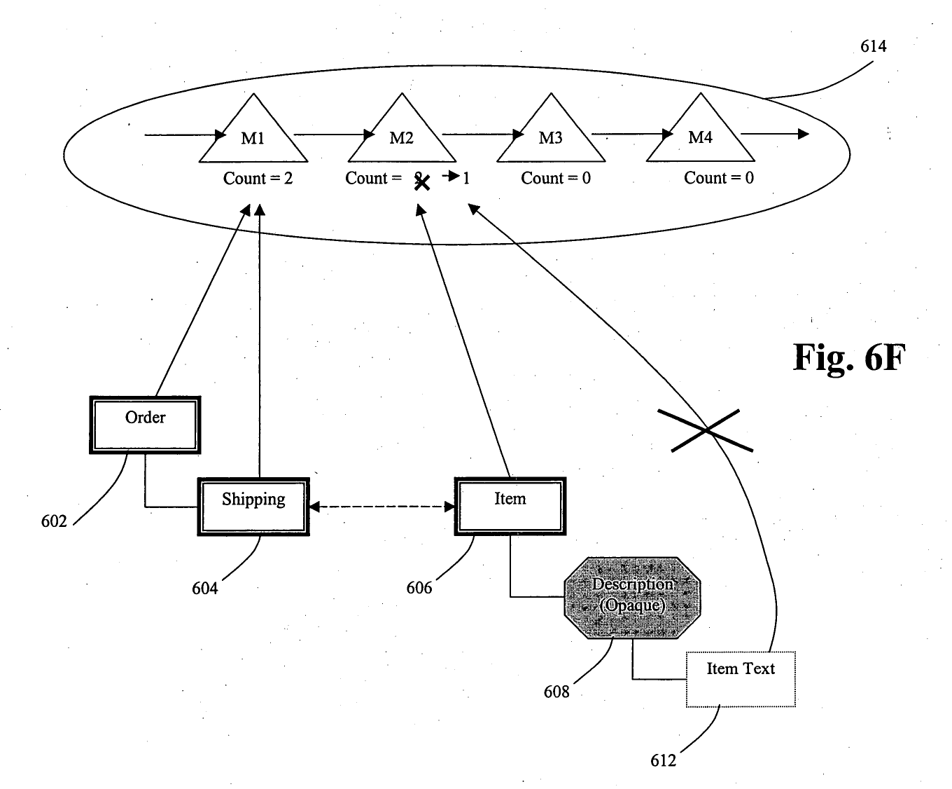

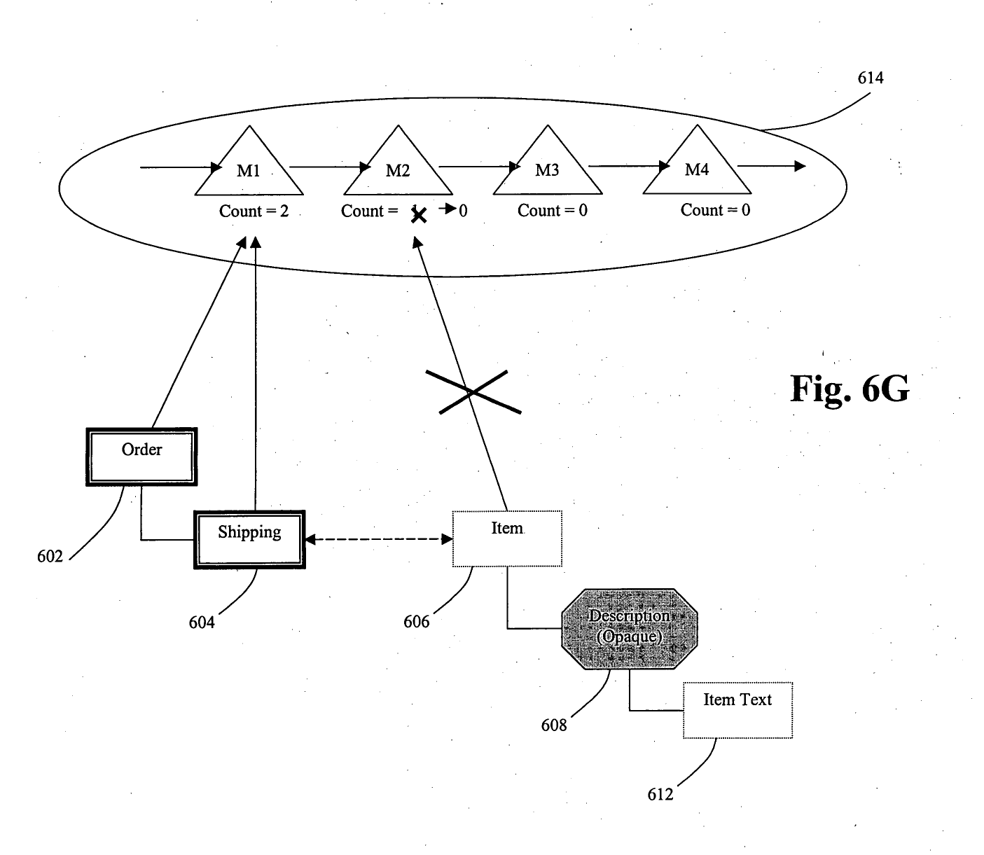

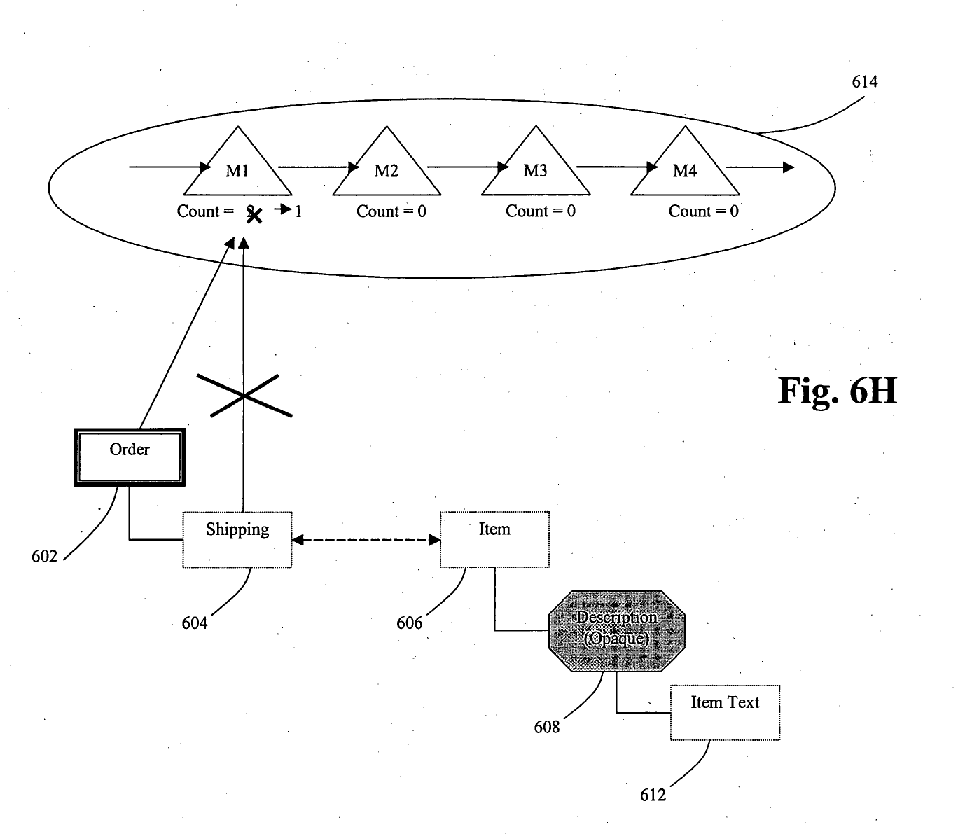

To illustrate the presently described approach, consider the hierarchy of objects shown in FIG. 6A:
Object Order 602 has one aggregate object Shipping 604;
Object Shipping 604 has an association relationship with object “Item” 606;
Object Item 606 has aggregate object Description 608, which is an opaque object;
Object Description 608 has an aggregate object Text 612 (which may not even be known to the system until the opaque object Description 608 has been processed).

A pool 614 of metadata objects exists in the system. The pool 614 includes a list of metadata objects M1, M2, M3, M4, etc. At the beginning of the process, assume that each of these metadata objects are un-allocated and have a refcount of zero.

It is desired to efficiently process all these objects for linearization or de-linearization (or any other type of desired process that may be performed upon objects, as described in more detail below) by allocating and initializing a minimum number of contexts. The method begins with a null list, and in this case, will process associations first, then aggregates.

Referring to FIG. 6B, the method begins by processing the Order object 602. At this point, it can be determined that this not an “association” situation and there are no existing contexts already allocated, so the method allocates a new context M1. This context M1 is initialized and the refcount for this context M1 is incremented from 0 to 1.

Next, the method follows the aggregations of the Order object 602 to the Shipping object 604, as shown in FIG. 6C. At this point, it is clear that this is not an association relationship that is being handled, but is instead an, aggregation situation. A check is performed of the first context (M1), which shows its count to be 1. Therefore, a search is performed backward through the list for the first element with a nonzero count, which is context M1. The method then re-uses M1 without initializing this context object M1. This approach is correct, as Order 602 and Shipping 604 are aggregations, share the same metadata, and therefore, could share the same context object M1. At this point, the refcount for context M1 is incremented from 1 to 2 (indicating that the processing of two separate objects, i.e., Order 602 and Shipping 604, both share this same context M1).

The method will next follow the association of Shipping 604 to Item 606, as illustrated in FIG. 6D. Here, the method knows that it is at an association relationship. Therefore, metadata in the context is not shared between this object 606 and the object 604 that it is associated with. Instead, the method will allocate a new context by searching through the list of free context objects (M2, M3, and M4) to find the first free context M2. This context M2 will be allocated and initialized. The refcount of this context M2 will be set to 1.

The Item object 606 has aggregate object Description 608, as shown in FIG. 6E. However, Description 608 is an opaque type that is handled through a callback by the client. Therefore, in conventional approaches, the system will lose track of the process until the client needs to process object Text 612, which is defined by and/or native to the system, and which happens to be part of Item 606.

The method will then process Text object 612. Here, it can be seen that the process is not at an association location, but is instead based upon an aggregation relationship. A check of the first context (M1) shows its count to be greater than zero (i.e., 2), so a backwards search is performed through the list 614 for the first context element with a nonzero count, which is M2. Context M2 is therefore re-used without being initialized. The refcount for M2 is incremented from “1” to “2”. This is the correct approach to re-use Item 606's context, even though there was no external information about which context to use. This is because in this embodiment, since the Item object 606 and the Text object 612 are related by an aggregation relationship, they have enough common metadata such that they can share the same context object.

Referring to FIG. 6F, assume that the linearization or de-linearization processing of Text object 612 has completed. At this point, Text 612 can be disassociated from context M2. As a result, the refcount for context M2 will be decremented from “2” to “1”. The system will then finish processing of Description 608.

Referring to FIG. 6G, the system then completes processing of Item 606. At this point, Item 606 can be disassociated from context M2. The refcount for context M2 can be decremented from “1” to “0”. Since the refcount for context M2 is now zero, this means that there are no further objects that are associated with this context. Therefore, context M2 can now be de-allocated, if an explicit de-allocation is required in the particular system to which the invention is applied.

Referring to FIG. 6H, assume that the linearization or de-linearization processing of Sipping 604 has completed. At this point, Shipping 604 can be disassociated from context M1. As a result, the refcount for context M1 will be decremented from “2” to “1”.

Referring to FIG. 6I, the system then completes processing of Order 602. At this point, Order 602 can be disassociated from context M1. The refcount for context M1 is decremented from “1” to “0”. Since the refcount for context M1 is now zero, this means that there are no further objects that are associated with this context. Therefore, context M1 can now be de-allocated, if an explicit de-allocation is required in the particular system to which the invention is applied.

In summary, this process employed only two allocated contexts, which was re-used throughout the process. In effect, this approach saved having to allocate additional contexts for the Shipping 604 and Text 612 objects, even though an opaque object Description 608 also appeared in the hierarchy of objects and is not natively known to the processing system. As this approach is used, the need for allocating contexts goes away altogether, as the list grows to fit the maximum one-time depth of the association tree, leaving enough space for any subsequent data tree of the same or smaller size.

This approach can be applied to any type of processing of objects, and provides a fast way to retrieve and use contexts. Any application working with objects that makes use of being able to retrieve large clusters of aggregate and associated data could be enhanced using this approach. This is a common scenario for clients retrieving data from databases, and processing data, which spans layers of context. The fact that the algorithm is transparent to the user means that anyone using it could allow clients to create and process their own objects without impacting performance or abstraction layers. For example, some scenarios in which hierarchies of database objects are pickled and un-pickled includes data-warehousing (in which large quantities of data are transferred from distributed database systems to one or more central data warehouses), replication systems, clustered systems, and load balancing systems, disaster and failover recovery systems, and any other application in which it is desirable to transfer large quantities of data, e.g., using streams.

As noted marshalling and un-marshalling are examples of a specific type of processing to which the invention may be applied. The described approach can be also used for other types of processing of objects. For example, the invention may be applied to make a copy of a hierarchy of objects. Also, the invention can be applied to convert a hierarchy of objects to a different language. Another example of an application to which the invention may be applied is to perform accounting upon a hierarchy of objects to derive or generate information.

### System Architecture Overview

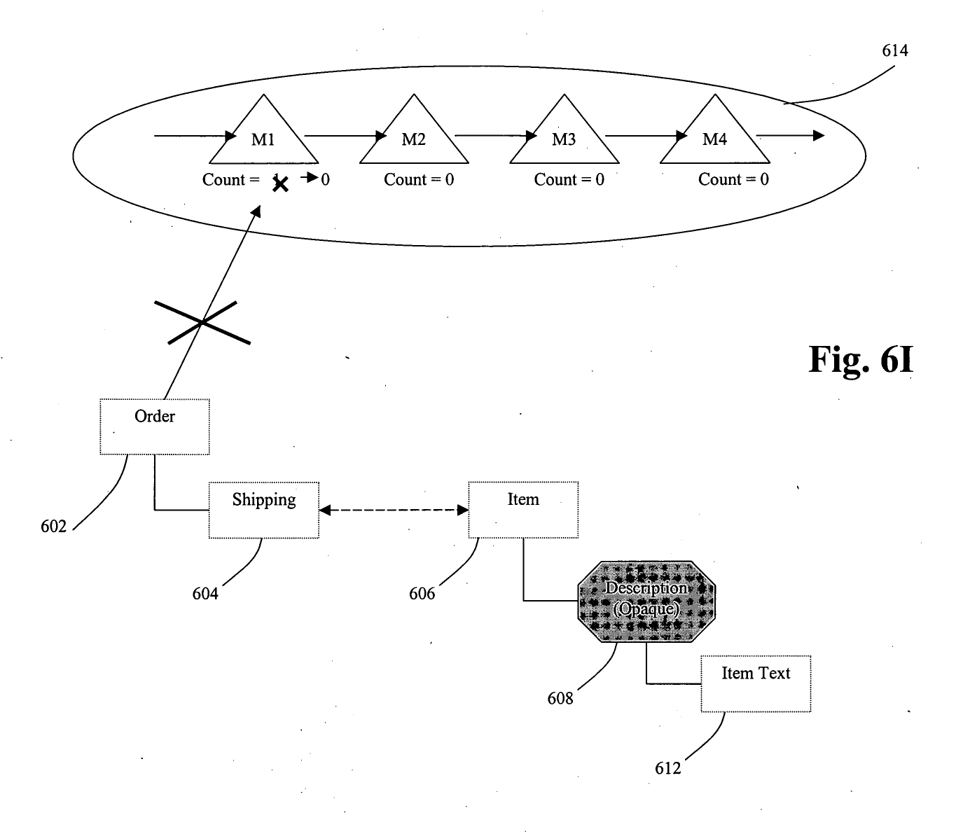

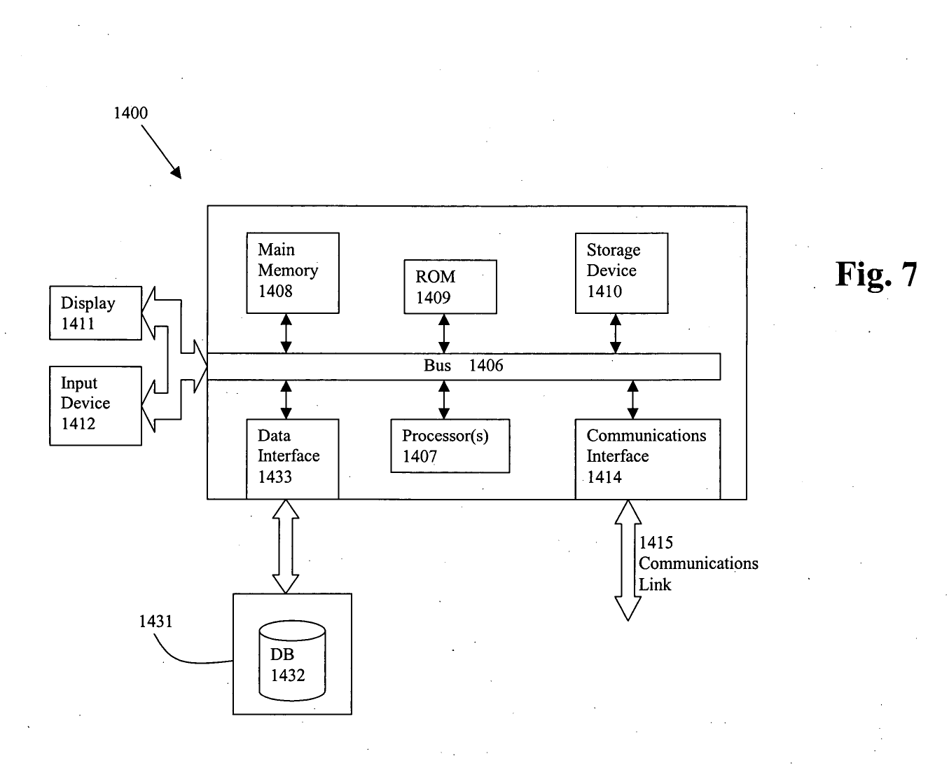

FIG. 7 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media, volatile media, and transmission media. Non-volatile media includes, for example, optical or magnetic disks, such as disk drive 1410. Volatile media includes dynamic memory, such as system memory 1408. Transmission media includes coaxial cables, copper wire, and fiber optics, including wires that comprise bus 1406. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A method for handling context information when processing a hierarchy of objects, comprising:
identifying a hierarchy of objects for processing, in which the hierarchy of objects comprises a first object, at least one item of opaque data that is not natively known to the database system, and a second object, wherein the first object, the second object, and the at least one item of opaque data have an aggregation relationship, in which the act of processing comprises either marshalling or unmarshalling;
processing the first object and the second object within the hierarchy of objects, in which the at least one item of opaque data is hierarchically disposed between the first object and the second object such that the first object is not directly aggregated to the second object; and
sharing a first context when processing the first object and the second object.

2. The method of claim 1 further comprising:
processing a third object which has an associate relationship with any of the first object, second object or opaque data; and
allocating a second context for processing the third object and not sharing the first context with the first and second objects.

3. The method of claim 1 in which the first context comprises metadata about the object and an image of the marshalling or unmarshalling operations.

4. The method of claim 1 in which processing of the first and second objects is handled depth first.

5. The method of claim 4 in which a return will not occur to an earlier context until handling of a present context is finished.

6. The method of claim 1 in which the first context is located in an accessible list.

7. The method of claim 6 in which the list comprises either a stack or a queue.

8. The method of claim 6 further comprising:
searching for the first non-shared context in the list if an association is begin processed.

9. The method of claim 6 further comprising:
determining if a top-level context corresponds to zero objects;
searching for an available context to share which corresponds to greater than zero objects; and
corresponding an object to the available context, such that he available context is shared with multiple contexts.

10. A computer program product comprising a tangible computer usable medium having executable code to execute a process for handling context information when processing a hierarchy of objects, the process comprising:
identifying a hierarchy of objects for processing, in which the hierarchy of objects comprises a first object, at least one item of opaque data that is not natively known to the database system, and a second object, wherein the first object, the second object, and the at least one item of opaque data have an aggregation relationship, in which the act of processing comprises either marshalling or unmarshalling;
processing the first object and the second object within the hierarchy of objects, in which the at least one item of opaque data is hierarchically disposed between the first object and the second object such that the first object is not directly aggregated to the second object; and
sharing a first context when processing the first object and the second object.

11. The computer program product of claim 10 further comprising:
processing a third object which has an associate relationship with any of the first object, second object or opaque data; and
allocating a second context for processing the third object and not sharing the first context with the first and second objects.

12. The computer program product of claim 10 in which the first context comprises metadata about the object and an image of the marshalling or unmarshalling operations.

13. The computer program product of claim 10 in which processing of the first and second objects is handled depth first.

14. The computer program product of claim 13 in which a return will not occur to an earlier context until handling of a present context is finished.

15. The computer program product of claim 10 in which the first context is located in an accessible list.

16. The computer program product of claim 15 in which the list comprises either a stack or a queue.

17. The computer program product of claim 15 further comprising:
searching for the first non-shared context in the list if an association is begin processed.

18. The computer program product of claim 15 further comprising:
determining if a top-level context corresponds to zero objects;
searching for an available context to share which corresponds to greater than zero objects; and
corresponding an object to the available context, such that he available context is shared with multiple contexts.

19. A system for handling context information when processing a hierarchy of objects, comprising:
means for identifying a hierarchy of objects for processing, in which the hierarchy of objects comprises a first object, at least one item of opaque data that is not natively known to the database system, and a second object, wherein the first object, the second object, and the at least one item of opaque data have an aggregation relationship, in which the act of processing comprises either marshalling or unmarshalling;
means for processing the first object and the second object within the hierarchy of objects, in which the at least one item of opaque data is hierarchically disposed between the first object and the second object such that the first object is not directly aggregated to the second object; and
means for sharing a first context when processing the first object and the second object.

20. The system of claim 19 further comprising:
means for processing a third object which has an associate relationship with any of the first object, second object or opaque data; and
means for allocating a second context for processing the third object and not sharing the first context with the first and second objects.

21. The system of claim 19 in which the first context comprises metadata about the object and an image of the marshalling or unmarshalling operations.

22. The system of claim 19 in which processing of the first and second objects is handled depth first.

23. The system of claim 22 in which a return will not occur to an earlier context until handling of a present context is finished.

24. The system of claim 19 in which the first context is located in an accessible list.

25. The system of claim 24 in which the list comprises either a stack or a queue.

26. The system of claim 24 further comprising:
means for searching for the first non-shared context in the list if an association is begin processed.

27. The system of claim 24 further comprising:
means for determining if a top-level context corresponds to zero objects;
means for searching for an available context to share which corresponds to greate than zero objects; and
means for corresponding an object to the available context, such that he available context is shared with multiple contexts.

28. A method for handling context information when processing a hierarchy of objects, comprising:
identifying a hierarchy of objects for processing, in which the hierarchy of objects comprises a first object, a second object, and at least one item of opaque data that is not natively known to the database system;
processing the first object and the second object within the hierarchy of objects, in which the at least one item of opaque data is hierarchically disposed between the first object and the second object such that the first object is not directly aggregated to the second object, wherein the first object, the second object, and the at least one item of opaque data have an aggregation relationship; and
sharing a first context when processing the first object and the second object.

29. The method of claim 28 further comprising:
processing a third object which has an associate relationship with any of the first object, second object or opaque data; and
allocating a second context for processing the third object and not sharing the first context with the first and second objects.

30. The method of claim 28 in which the first context is located in an accessible list.

31. The method of claim 30 further comprising:
determining if a top-level context corresponds to zero objects;
searching for an available context to share which corresponds to greater than Zero objects; and
corresponding an object to the available context, such that he available context is shared with multiple contexts.
